(19) United States
(12) Patent Application Publication
(10) Pub. No.: US 2011/0252653 A1
(43) Pub. Date: Oct. 20, 2011

(54) ADJUSTABLE HANDLE FOR HAND HELD CIRCULAR SAW

(76) Inventor: Jason Twedell, Riverside, CA (US)

(21) Appl. No.: 13/022,302

(22) Filed: Feb. 7, 2011

Related U.S. Application Data
(60) Provisional application No. 61/342,763, filed on Apr. 19, 2010.

(51) Int. Cl. B23D 59/00

(52) U.S. Cl. 30/519

(57) ABSTRACT

A handle is disclosed that can be added to a hand held electric worm-drive circular saw. The additional handle of the adjustable handle for a hand held electric circular saw may be attached to the front miter gauge of the hand held worm-drive circular saw. The addition of the adjustable handle for a hand held electric circular saw provides added work visibility, better handling ability, greater control when cutting, improved safety, and a better ergonomic fit for the user. The adjustable handle for a hand held electric circular saw also provides a means for applying downward force at the front and the ability to lift the front portion of the saw during cutting operation as well as providing a better balance point for cutting and carrying.

### CROSS REFERENCE TO RELATED APPLICATION

This application claims the benefit of Provisional 61/342,763 filed Apr. 19, 2010 the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention relates hand held electric power saws. More particularly this invention relates to a handle that may be added to existing hand worm drive circular saws to enable them to be carried and used with greater ease.

2. Description of Related Art Including Information Disclosed Under 37 CFR 1.97 and 1.98

Hand held electric circular saws have been around for some time. A hand held electric circular saw is a portable electrically powered saw that is held by hand during use. Typical hand held electric power saws deliver about one horse power to the cutting blade making them suitable for cutting two by fours, plywood, and other wood products up to a couple of inches in thickness. The portability and power available with hand held electric circular saws makes them an ideal tool of choice for construction applications.

Hand held electrical circular saws for household use by consumers tend to be very light in weight due to the consumer need for low cost and intermittent use. These low cost light weight portable saws should not be used continuously for more than a couple of minutes. Continuous use of consumer grade hand held electric power saws may cause them to overheat and fail.

Hand held electric circular saws for industrial use employ heavier higher grade materials that provide a saw that is more suited towards periods of continuous use exceeding several minutes at a time. Unlike consumer grade hand held electric circular saws, industrial grade hand held electric circular saws often employ a second handle to enable the user to use these heavier saws.

Consumer grade hand held electric circular saws usually employ a single handle at the back end of the saw that is fitted with a trigger switch. The user simply holds on to the handle, pulls the trigger with his finger and pushes the saw through the material. The one horsepower motor then cuts through the material in a rapid manner. These saws provide enough power to complete a few cuts before overheating and burning out. Because light duty consumer applications only require a few cuts to be made at a time, low cost, lightweight, and portability are more important than durability. In particular, continuous use durability is not a requirement for consumer grade hand held electric circular saws. In addition, because of their infrequent use, consumer grade hand held electric circular saws do not have to be engineered for making a large number of cuts over, the life of the tool. The minimal requirements of consumer grade hand held electric circular saws allow them to be made light in weight. In particular, small light weight electric motors used in these saws can be made to provide large amounts of power.

Industrial grade hand held electric circular saws, also known as worm drive saws are designed for more continuous use than the consumer grade saws. Because of this these saws weigh considerably more than their consumer grade counterparts. The added weight of industrial grade hand held electric circular saws compared to the consumer grade saws often requires them to be held with both hands. This often requires industrial grade hand held electric circular saws to be fitted with a second handle.

The location and geometry of the handle with saws intended for Household use is somewhat limited based on a compromise between utility and comfort. For industrial use, the location of both handles is not ideal for each and every application. This results in an ergonomically improper condition for both household as well as industrial users. For example, handle locations and geometries in both household and industrial electric circular saws have certain drawbacks. In particular with household hand held circular saws the individual must control the saw with only one hand, and with industrial hand held circular saws the location of the second handle may not be best suited for every application. Household handheld electric circular saws suffer from the possibility of bodily injury resulting from the circular saw cutting the user. This is because the free hand of the operator is not holding the saw may sustain injury from direct contact with the blade.

Industrial grade hand held electric circular saws having two handles provide greater stability, safety, and comfort than hand held electric power saws having only one handle. Because both hands are used to hold the saw, the possibility of cutting the hands by direct contact with the blade is eliminated when the saw is used as intended. Unfortunately, many individuals using the two handle industrial saws do not use both handles. In particular, many individuals hold the back portion of the saw with one hand and hold the front of the saw with the other, grabbing the miter gauge or table. This is a dangerous practice that is often carried out when making various cuts.

Neither single handle nor double handle hand held circular saws allow for significant downward pressure on the front portion of the saw or the ability to lift pressure off the front of the saw if it gets stuck. This lack of pressure on the front portion of the saw increases the likelihood of the saw kicking back and injuring the user. This is due to controlling the saw and eliminates the blade binding. Furthermore, visibility of the area in front of the cut is limited. This limited visibility is the result of the user having to lean forward and around the user's arm holding the second existing handle located in the center of the saws to view the work area in front of the cut or at the front of the blade. Both single handled and dual handled hand held electric circular saws of the prior art have a rearward balance point that may not be suited for each and every application.

Portability is another issue. Industrial grade hand held electric circular saws tend to be somewhat heavy. Carrying the saw with either of the provided handles tends to be somewhat bulky and awkward. Placing the added handle on the front portion of the saw provides a less awkward means for carrying the saw, handling the saw, setting down and picking-up the saw. Also handing off the saw to another user.

### BRIEF SUMMARY OF THE INVENTION

It is an object of the adjustable handle for a hand held electric circular saw to provide an additional multi positioning handle that retrofits onto worm drive hand held circular saw miter gauge. Using existing saw hardware to allow for safer, easier, more visible, ergonomic work and controlled cuts.

It is further an object of the adjustable handle for a hand held electric circular saw to provide a handle for existing electric worm drive circular saws that provides added stability for the user during use by offsetting some weight thereby transferring the weight forward. This gives more control and reduces saw kickback and better saw blade visibility.

It is a further object of the adjustable handle for a hand held electric circular saw to provide an additional handle for hand held electric worm drive circular saws without the need to modify the original saw or the need to add any hardware. The handle rotates up to 180 degrees for various positions (ergonomically designed for all angles left, center and right. Adjustable position makes cuts easier and more comfortable.

It is a further object of the adjustable handle for a hand held electric circular saw to mount the additional handle in a low profile and forward configuration for added stability during use, and weight balance transfer. This adds a unique aspect of safety that helps push the saw through material. Because the saw handle retrofits to the saw miter gauge thereby allowing the saw handle to stay fully functional.

It is a further object of the adjustable handle for a hand held electric circular saw to provide a low cost and efficient mounting means for adding an additional handle to hand held worm drive circular saws. The handle fits most standard saws that are manufactured or sold by Skil, Dewalt, Bosch, Millwakee, Rigid and Makita hand held circular saws.

The adjustable handle for a hand held electric circular saw therefore proposes a secondary handle that may be added to existing hand held electric circular saws in order to increase comfort stability and handleability of the saw during use. The secondary adjustable handle for a hand held electric circular saw enables the user to hold the saw with both hands by providing an additional handle that may be mounted to the miter portion of the saw. This mounting may be carried out using the slot in the miter gauge attached to the table. Alternatively, the added adjustable handle for a hand held electric circular saw may be mounted to the existing bolt used to adjust the miter angles of the saw. The result is a handle that is easily added to existing hand held electric circular power saw that improves stability and comfort during use and improves portability the handling ability. The single hole mounting of the handle and the control of the handle to the saw provides a means for rotating the handle into numerous positions for greater ease, comfort, safety, handling ability and stability during use.

Various objects, features, aspects, and advantages of the present of the adjustable handle for a hand held electric circular saw will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows a standard hand held electric worm drive circular saw of the prior art.

FIG. 2 shows the front portion of a hand held electric worm drive circular saw showing the miter portion suitable for attaching the added adjustable handle for a hand held electric circular saw.

FIG. 3 shows a top view of the adjustable handle for a hand held electric circular saw.

FIG. 4 shows a profile view of the saw handle of the adjustable handle for a hand held electric circular saw.

FIG. 5 shows the miter portion of a hand held electric worm-drive circular power saw along with the attached adjustable handle for a hand held electric circular saw in the right side configuration.

FIG. 6 shows the miter portion of a hand held electric circular saw with the adjustable handle for a hand held electric circular saw shown in the vertical position.

FIG. 7 shows a hand held electric circular saw in complete form having the attached adjustable handle for a hand held electric circular saw in the vertical position.

### DETAILED DESCRIPTION OF THE INVENTION

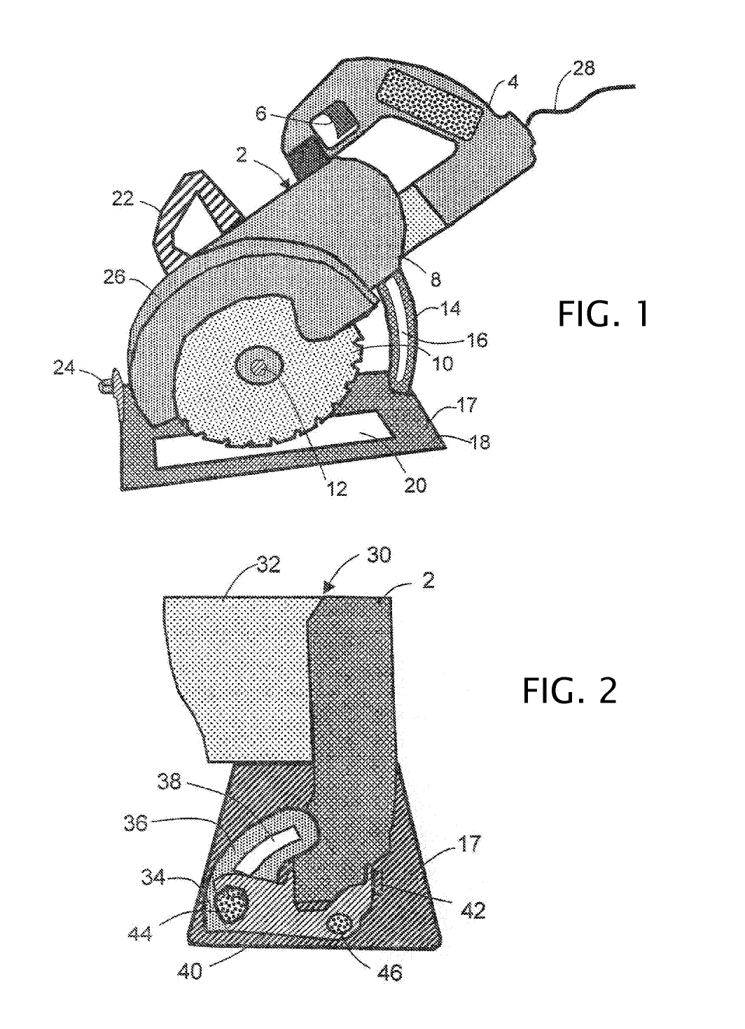

FIG. 1 shows a standard hand held electric worm-drive circular saw of the prior art.

Industrial grade hand held electric power saw 2 is shown having rear handle 4 for holding the back portion of the saw. Also shown is trigger switch 6 which may be depressed to activate the saw. Also shown is motor portion 8 attached to a gearbox (not shown). The gearbox attached to motor portion 8 is used to reduce the RPM and increase the torque output of motor portion 8. Also shown is blade 10. Blade 10 is fixedly attached to the gear box with bolt 14. Motor portion 8 of saw 2 is shown against rear mounting portion 14. Rear mounting portion 14 is shown having a slot 16. Slot 16 of rear mounting portion 14 provides a slidable assembly allowing for adjustment of cut depth of blade 10. Also shown is base 17. Base 17 is shown having a solid portion 18 and slot 20. Slot 20 provides a place for blade 10 to extend through base 17. Also shown is second handle 22. Second handle 22 provides added support for the user. Also shown is miter 24. Miter 24 provides rotatable adjustment for saw 2 for making miter cuts. Guard 26 is also shown. Guard 26 surrounds the top part of blade 10 and provides protection to the user. Cord 28 is also shown and provides electric power to saw 2.

FIG. 2 shows the front portion of a hand held electric power saw showing the miter portion suitable for attaching the added adjustable handle for a hand held electric circular saw. Front portion 30 of saw 2 is shown having gear box 32 along with miter assembly 34 attached to base 16. Miter assembly 34 consists of miter 36 having slot 38 along with mounting hardware 40. Mounting hardware 40 is shown attaching the main portion of saw 2 to base 17 to miter 34. Attachment screw 42 attaches mounting hardware 40 to the main portion of saw 2. Bolt 44 of mounting hardware 40 extends into slot 38 of miter 36 thereby allowing the main portion of saw 2 to tilt for miter cuts. Bolt 46 provides a pivot point of attachment between mounting hardware 40 and base 17.

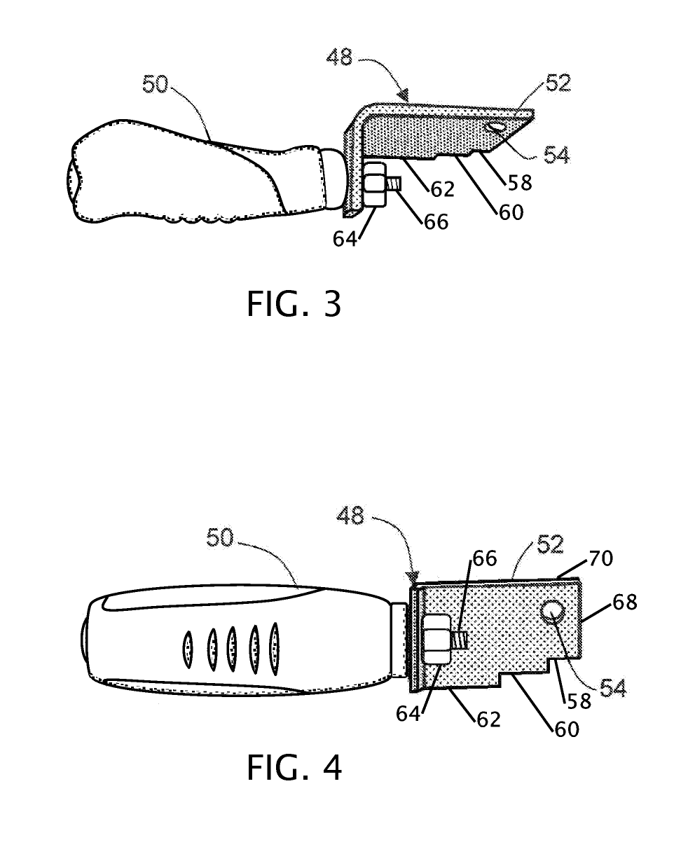

FIG. 3 shows a top view of the adjustable handle for a hand held electric circular saw. Handle 48 is shown having grip 50 along with bent metal portion 52. In the preferred embodiment the grip 50 is cushioned to reduce vibration. Also shown is hole 54 in bent metal portion 52. Hole 54 in bent metal portion 52 provides a rotatable attachment means for fastening handle 48 to the miter portion of the saw (not shown). The metal portion 52 includes a series of steps 28, 60 and 62 that create stops to prevent the handle from being rotated below the cutting surface and also allows the handle to be adjusted to various angles on the miter of a circular saw. In this embodiment the bent metal portion is secured to the grip 50 with a stud 66 that extends from the grip 50. The bent metal portion 52 is secured to the grip with a nut 64.

FIG. 4 shows a profile view of the adjustable handle for a hand held electric circular saw. Handle 48 is shown having grip 50 along with bent metal portion 52. Also shown is hole 54 in bent metal portion 52. Hole 54 in bent metal portion 52 provides a rotatable attachment means for fastening handle 48 to the miter portion of the saw (not shown). The hole 54 is positioned offset from the centerline of the grip 50 and positioned at optimal distances from the steps 58, 60 and 62 to accommodate the different geometries of hand held electric miter saws that are manufactured by different companies. In addition to the steps 58, 60 and 62 the end edge 68 and the top edge 70 can be utilized to provide mechanical stops.

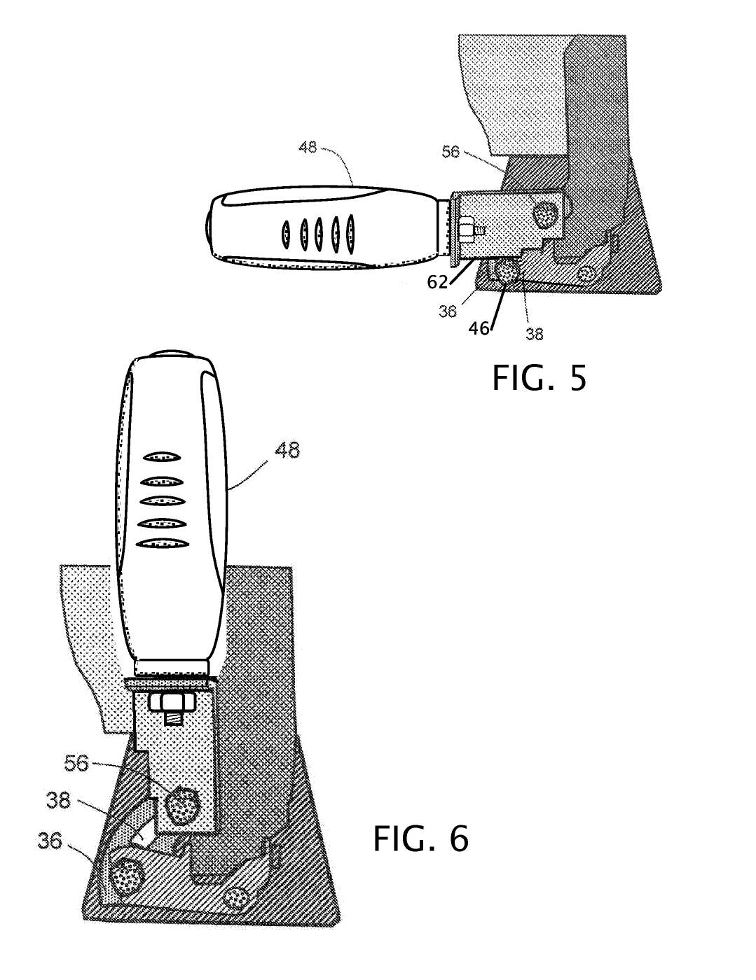

FIG. 5 shows the miter portion of a hand held electric power saw along with the attached adjustable handle is custom formed for a hand held electric circular saw in the horizontal position. Handle 48 is shown attached to slot 38 of miter 36 with bolt 56. Handle 48 is shown mounted in the horizontal position where step 3 is in contact with locking bolt head 46 to prevent over rotation of the adjustable handle grip 48 below the work surface. This configuration allows the user to push the front part of the saw in a manner that controls the side to side cutting direction. This added control gives the user greater ability to control the direction of the cut by manipulating the direction of the force across the handle. Furthermore, with one hand in the front portion of the saw, the user can easily lean over closer to the cut for improved visibility.

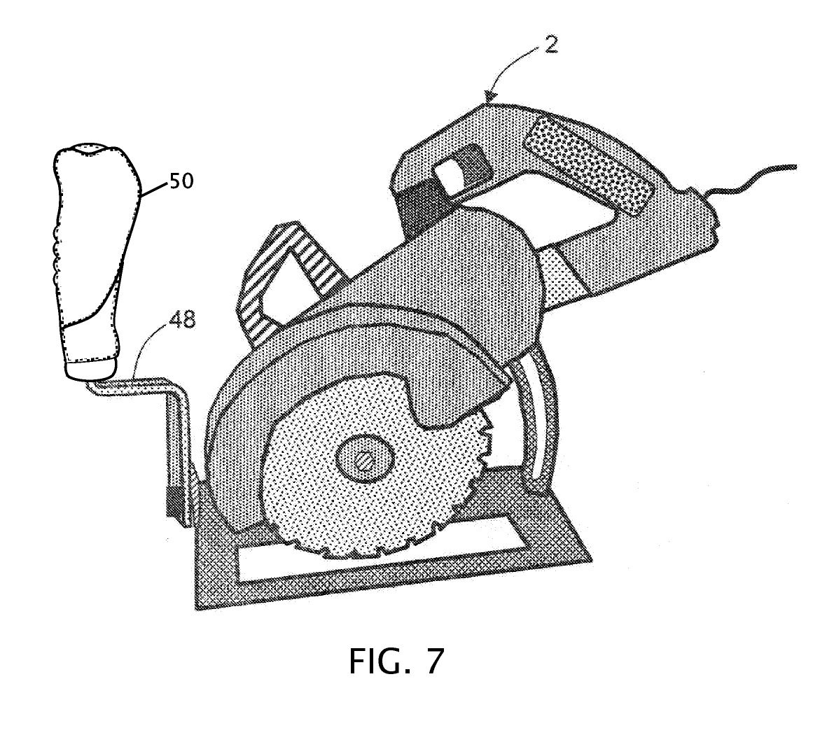

FIG. 6 shows the miter portion of a hand held electric power saw with the adjustable handle for a hand held electric circular saw shown in the vertical position. Handle 48 is shown attached to slot 38 of miter 36 with bolt 56. Handle 48 is shown mounted in the vertical position. This configuration allows the user to place added downward force on the front portion of the saw without affecting cutting direction. The addition of downward force on the front of the saw gives greater stability of the saw during cutting and reduces the likelihood of kick back.

FIG. 7 shows a hand held electric power saw in complete form having the attached handle for a hand held electric circular saw in the vertical position. Hand held electric power saw 2 is shown in complete form with added handle 48 of the adjustable handle for a hand held electric circular saw. In this embodiment the handle 48 is shown molded into the grip 50.

Thus, specific embodiments of an adjustable handle for a hand held electric circular saw have been disclosed. It should be apparent, however, to those skilled in the art that many more modifications besides those described are possible without departing from the inventive concepts herein. The inventive subject matter, therefore, is not to be restricted except in the spirit of the appended claims.

1. An adjustable handle for a hand held circular saw comprising:
a handle;
an arm extending from said handle;
said arm having a hole that fits through a miter adjustment bolt on a circular saw;
a hand held circular saw;
said handle provides an adjustable front grip for said circular saw;
said arm further having a plurality of steps in proximity to said hole whereby;
said steps provide stops to allow said handle to be positioned at various angles to said circular saw above a cutting surface.

2. The adjustable handle for a hand held circular saw according to claim 1 wherein said steps comprise at least two steps.

3. The adjustable handle for a hand held circular saw according to claim 1 wherein said steps comprise at least three steps.

4. The adjustable handle for a hand held circular saw according to claim 1 wherein said hole is offset from a centerline of said handle.

5. The adjustable handle for a hand held circular saw according to claim 1 wherein said arms is secured to said handle with a fastener.

6. The adjustable handle for a hand held circular saw according to claim 5 wherein said fastener is a nut.

7. The adjustable handle for a hand held circular saw according to claim 1 wherein said arm is molded into said handle.

8. The adjustable handle for a hand held circular saw according to claim 1 wherein said arm is made from metal.

9. The adjustable handle for a hand held circular saw according to claim 1 wherein said hand held circular saw is a worm drive circular saw.

10. The adjustable handle for a hand held circular saw according to claim 1 wherein said handle is cushioned.

11. The adjustable handle for a hand held circular saw according to claim 1 wherein said steps prevent rotating said handle below a work surface of said hand held circular saw.

12. The adjustable handle for a hand held circular saw according to claim 1 wherein said handle mounts to said hand held circular saw in front of a saw blade in said hand held circular saw.

13. The adjustable handle for a hand held circular saw according to claim 1 wherein said handle is custom formed.
